(19) United States
(12) Patent Application Publication
(10) Pub. No.: US 2008/0309544 A1
(43) Pub. Date: Dec. 18, 2008

(54) Method of Explosives Detection and Identification

(76) Inventors: Oleg Vladimirovich Diyankov, Moscow Region (RU); Yury Ilich Cherches, Moscow (RU); Sergei Genrikovich Karabashev, Moscow (RU); Grigory Arnoldovich Stepanyan, Moscow (RU)

Correspondence Address: Nikolay Borsch-Kompaneets;Juris Ooo PCK, 2 Smolenskiy per.3/4 Office 418, Moscow, 121099, RU

(21) Appl. No.: 11/661,476

(22) PCT Filed: Sep. 8, 2005
(86) PCT No.: PCT/RU05/00456

§ 371 Date: Feb. 27, 2007

(30) Foreign Application Priority Data
Sep. 9, 2004 (RU) 2004126993

(51) Int. Cl. G01S 13/00

(52) U.S. Cl. 342/22

(57) ABSTRACT

A proposed method of detection and identification of explosives and drugs in an object comprises the steps of: generating an emitted UHF signal carried by pulse fixed carrier frequency electromagnetic waves with predetermined carrier frequency, deviation, duration, and amplitude; exposure of the object to the emitted signal; reception of a reflected signal; its amplification and processing; measuring its phase and intensity, the emitted and received signals difference and an absorption ratio, determining a phase lag between the received and emitted signals; comparing the lag with a preset lag value stored in memory, obtaining a lag difference; detecting and identifying the explosives and drugs based on the lag difference and taking into account the absorption ratio, wherein the ratio and lag difference are correlated to predetermined dielectric properties of certain types explosives or drugs inclusions. The emitted signal can be formed as a sequence of waves with increasing or decreasing frequencies.

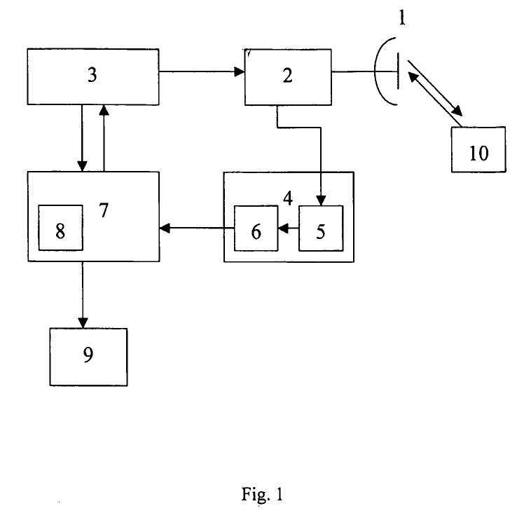

### CROSS-REFERENCE TO RELATED APPLICATIONS

This application is a U.S. national phase application of a PCT application PCT/RU2005/000456 filed on 8 Sep. 2005, whose disclosure is incorporated herein in its entirety by reference, which PCT application claims priority of a Russian Federation patent application RU2004126993 filed on 9 Sep. 2004.

### TECHNICAL FIELD

The present invention relates to explosives and drugs detection techniques, in particular, to methods of detection and identification of explosives and drugs in various confined premises and on the human body, and also at locations where crowds of people may gather.

### BACKGROUND OF THE INVENTION

There is a known method of detection, identification, and tracing of organic matter, including explosives and drugs using pulse streams of fast neutrons, which comprises exposure of an object under control to irradiation in the form of pulse streams of fast neutrons, including a plurality of neutron pulses, registering characteristic gamma-quanta created during non-elastic collisions of the fast neutrons with organic matter nuclei, determining a registered time of the characteristic gamma-quanta vs. the beginning of a neutron pulse, detecting the organic matter by the fact of registration of the characteristic gamma-quanta, identifying the organic matter by the proportion of characteristic gamma-quanta of various energy and tracing the organic matter, wherein uncollimated streams of fast neutrons are used for the irradiation, and a collection of data on the registered time of the characteristic gamma-quanta obtained at several (no fewer than three) positions of the apparatus relative to the object being exposed to irradiation (RU 2002102468, G01N 23/222, 10.10.2003).

The disadvantages of the above method include a relative complexity of the equipment used for it and the impossibility of using it at the locations with presence of people.

Another method of detecting drugs and explosives, described in RU 2179716 (G01N 24/00, 20.02.02), comprises: placing an object being checked in one measuring chamber; placing a reference sample having the same chemical composition as the substance is to be identified in another chamber; exposure of the object being checked and the reference sample to a radio-frequency signal with a predetermined frequency value and a type of sequence of fixed-frequency electromagnetic waves; alternate reception of the signals with the use of receiving antennas installed in the aforesaid measuring chambers; processing the received signals by an analog-digital converter; accumulation of the processed information; and using the Fourier conversion with a subsequent comparison of the NQR spectrum of the object being checked and the reference sample, the results of which allow to make a conclusion about the presence of explosives or drugs.

The disadvantages of the RU 2179716 solution are: a relative complexity of explosives detection due to the necessity of using two measuring chambers in order to ensure, for the reference sample, the conditions identical with those for the object being checked; the presence of the operations related to the Fourier conversion; and the impossibility of using this solution in mobile explosives detection facilities intended for use at locations, where crowds of people may gather and in confined premises.

### SUMMARY OF THE INVENTION

The present invention is proposed to eliminate the indicated disadvantages, substantially by providing a simple and reliable explosives and drugs detection and identification method, which can be used in stationary and mobile devices intended for use at the locations, where crowds of people may gather, and in various confined premises.

The inventive method of detection and identification of explosives and drugs in (or on) an object being checked comprises the steps of: generating an emitted (or probe) ultra-high-frequency (UHF) signal carried by a number of pulse fixed carrier frequency electromagnetic waves with predetermined values of carrier frequency, frequency deviation, duration, and amplitude (herein further called FFW); exposure of the object to irradiation of the emitted UHF signal; reception of a signal reflected (received UHF signal) from the object; amplification and processing (substantially an analog-digital conversion) of the received signal; measuring a phase parameter and an intensity parameter of the received signal; determining a difference between the emitted signal intensity and the received signal intensity, and an absorption ratio of the object based on the intensities difference; determining a measured phase lag between the measured phase value of the received signal and the phase value of the emitted signal; comparing the measured phase lag value with a respective preset phase lag value stored in memory and obtaining a phase lag difference; and detecting and identifying the presence of the explosives and drugs based on the phase lag difference and taking into account the value of the absorption ratio, wherein the absorption ratio and the phase lag difference are correlated to predetermined dielectric properties of the inclusions of certain types of explosives or drugs.

The exposure of the object to the UHF irradiation is preferably provided by FFW in a frequency range from 300 MHz to 150 GHz with a duration of the FFW not exceeding 10 ms and a predetermined maximum deviation. Specifically, the FFW is herein characterized as an electromagnetic pulse wave of a predeterminedly low amplitude and a carrier frequency preset with a high precision, i.e. the deviation of the carrier frequency is substantially and predeterminedly less than the carrier frequency itself.

For exposure of the object to the irradiation, the emitted UHF signal can be generated in the from of a fixed carrier frequency pulse electromagnetic wave sequence (FFW sequence) with the carrier frequency of every subsequent FFW differing from the carrier frequency of the previous FFW by a preset value. The carrier frequency in the subsequent FFW vs. the previous FFW can be changed either towards increasing the carrier frequency value or towards decreasing it.

### A SAMPLE PREFERRED EMBODIMENT OF THE PRESENT INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

The attached figure shows a functional diagram of an apparatus for implementation of a preferred embodiment of the proposed explosives and drugs detection and identification method. The apparatus comprises an antenna (1) connected through an antenna switch (2) with the output of a UHF transmitter (3), capable to transmit (or emit) probe fixed carrier frequency pulse electromagnetic waves (FFW as defined above) carrying UHF probe signals, and with the input of a UHF receiver (4) capable to receive UHF signals (carried by reflected FFW) reflected from an object being checked (10), which receiver 4 includes an amplifier (5) and an analog-digital converter (6), the output of the analog-digital converter 6 is connected to a measuring device (7), including a memory unit (8), and the measuring device 7 is connected to a display unit (9). The measuring device 7 and the transmitter 3 are inter-connected via a synchronization circuit (not illustrated).

In some embodiments, the measuring device 7, deploying a suitable conventional processor, will enable control of parameters of the UHF probe signal over control circuits of the transmitter 3. Specifically, one can set required values of the amplitude and duration of the UHF probe signal, its power and the carrier frequency and specify the carrier frequency values for each FFW in the case when the UHF probe signal, used to expose the object 10 to irradiation, is transmitted in the form of a sequence of FFW.

In other embodiments, the apparatus can be designed with two antennas, one of which will be transmitting, and the other one will be receiving. In such embodiments, the apparatus will not include an antenna switch, since the antennas will be connected to the output of the transmitter and the input of the receiver, respectively.

The inventive explosives and drugs detection and identification method in (or on) an object being checked may be exemplarily implemented in a preferred embodiment as described below.

The method comprises generating an emitted (or probe) ultra-high-frequency (UHF) signal carried by a number of pulse fixed carrier frequency electromagnetic waves with predetermined values of carrier frequency, frequency deviation, duration, and amplitude (FFW).

The generating is preferably provided in a frequency range from 300 MHz to 150 GHz with a duration of the FFW not exceeding 10 ms and a predetermined maximum deviation. Specifically, the FFW is herein characterized as an electromagnetic pulse wave of a predeterminedly low amplitude and a carrier frequency preset with a high precision, i.e. the deviation of the carrier frequency is substantially and predeterminedly less than the carrier frequency itself.

The UHF signal can be generated in the form of a sequence of FFW. In this case, every FFW will be given a dedicated carrier frequency value, whereas a carrier frequency value for the subsequent wave will be predeterminedly either increased or reduced, that is the predetermined difference (or a preset difference value) between the previous and subsequent waves might be either positive or negative.

The emitted UHF signal with predetermined parameters, generated in the transmitter 3, enters, via the antenna switch 2, the antenna 1, and is emitted towards the object 10 providing the next step: exposure of the object. Since the power of the emitted UHF signal is predeterminedly low, not only various objects and luggage, but also passengers or people present at the locations of mass activities can be securely checked for explosives or drugs directly.

The UHF signal reflected from the object 10 (received signal) is received (the reception step) by the antenna 1 and arrives, via the antenna switch 2, at the input of the receiver 4, in which receiver 4 it is amplified by the amplifier 5 and converted by the analog-digital converter 6 into the form convenient for further processing in the measuring device 7 (the amplification and processing step).

The device 7 can be designed, for instance, using a suitable conventional processor, which allows the digital processing of the received signals, determining their phase lag values vs. the emitted signals, determining their intensities values (the steps of measuring and determining parameters) and an absorption ratio based thereon, and subsequently comparing these phase lag values and the absorption ratio value with the corresponding reference values stored in the memory unit 8 (the comparing step).

If the object 10 (luggage, a human body, etc.) has any specific dielectric inclusions, the parameters of the received signal will be different from the parameters of the received signals reflected from an object, which does not contain any explosives, drugs, etc. The differences can be registered as the phase lag change and as the intensities change (represented by the change of the absorption ratio) of the received signal versus the emitted signal.

The phase changes will be different for various dielectrics. An explosive or a drug (narcotic substance) can be identified by (a) comparing the phase lag values of the received signals vs. the emitted signals with predetermined reference phase lag values stored in the memory unit 8 and (b) taking into account the aforesaid absorption ratio (the detection and identification step). These operations allow determining differences corresponding to the dielectric properties of the inclusions of certain types of explosives or drugs. The data so obtained can be displayed in the display unit 9.

In the simplest case a lighting indicator can be used, which will testify the detection of explosives or drugs.

Therefore, the proposed method can be implemented with the use of simple equipment enabling a reliable detection and identification of explosives or drugs, and solves the aforementioned problems of prior art methods and devices.

1-4. (canceled)

5. A method of detection and identification of explosives and drugs in an object being checked, comprising the steps of:
generating an emitted UHF signal carried by a number of pulse fixed carrier frequency electromagnetic waves with predetermined values of carrier frequency, frequency deviation, duration, and amplitude; said emitted UHF signal having an intensity value and a phase value;
exposure of the object to irradiation of the emitted UHF signal;
reception of a UHF signal reflected from the object;
amplification and processing the received signal;
measuring a phase and an intensity of the received signal;
determining a difference of the intensities between the emitted and received signals, and an absorption ratio of the object based upon the intensities difference;
determining a measured phase lag between the measured phase value of the received signal and the phase value of the emitted signal;
comparing the measured phase lag value with a respective preset phase lag value stored in memory and obtaining a phase lag difference; and
detecting and identifying the presence of said explosives and drugs based on said phase lag difference and taking into account the value of said absorption ratio, wherein said absorption ratio and said phase lag difference correlated to predetermined dielectric properties of the inclusions of certain types of explosives or drugs.

6. The method according to claim 5, wherein
the value of the amplitude predeterminedly low, enabling a secure exposure of the object;
the predetermined value of the frequency of said emitted UHF signal provided in a frequency range from 300 MHz to 150 GHz;
the predetermined value of the duration of said emitted signal not exceeding 10 ms; and
the predetermined value of the frequency deviation being substantially and predeterminedly less than said predetermined value of the frequency of said emitted UHF signal.

7. The method according to claim 6, wherein
wherein the emitted UHF signal generated in the form of a sequence of said pulse fixed carrier frequency electromagnetic waves with the carrier frequency of every subsequent wave differing from the carrier frequency of the previous wave by a preset difference value.

8. The method according to claim 7, wherein
said preset difference value being positive.

9. The method according to claim 7, wherein
said preset difference value being negative.
